(19) United States
(12) Patent Application Publication
(10) Pub. No.: US 2004/0049598 A1
(43) Pub. Date: Mar. 11, 2004

(54) Content distribution system

(76) Inventors: Dennis Tucker, Irving, TX (US); Shing-Ping Liu, Irving, TX (US)

Correspondence Address: Darren W. Collins, Esq., Patton Boggs, LLP, 2001 Ross Avenue, Suite. 3000, Dallas, TX, 75201, US

(21) Appl. No.: 09/791,964

(22) Filed: Feb. 23, 2001

Related U.S. Application Data
(60) Provisional application No. 60/184,524, filed on Feb. 24, 2000.

(51) Int. Cl. G06F 15/16

(52) U.S. Cl. 709/246; 709/217

(57) ABSTRACT

The present invention generally relates to a content delivery system that utilizes editing, caching and compressing to speed the delivery of content from a network, such as the Internet, while conserving bandwidth usage. A local computer sends a request for content to a computer on a first network (the Internet) through a second network (such as an ISP or Intranet). The request is intercepted by a Proxy Server which is coupled to an Editor and Compressor. The Proxy Server returns the requested content to the requestor in a compressed form and in such a manner that the delivery of such content is faster than the current state of the art.

### FIELD OF THE INVENTION

The invention relates generally to information retrieval and more particularly to the retrieval of information that has been optimized for delivery through editing and compression.

### BACKGROUND OF THE INVENTION

As the Internet evolves, the amount of information available to users of the Internet expands exponentially. Available information comes in various forms, ranging from text to images. Some content is often delivered to the user, hereinafter referred to as the requestor, in compressed form. That portion of the compressed content which takes the form of an image is usually compressed using lossy compression techniques such as JPEG (Joint Photographic Experts Group), GIF (Graphics Interchange Format) or MPEG (Moving Picture Experts Group). Lossy compression is a compression technique in which a large file (such as graphics, video, or audio files) can be stored in a smaller amount of space than lossless compression, but some loss of quality will result when the file is decompressed. MPEG is a common type of lossy video compression that is used to deliver video content over the World Wide Web (WWW) Content compressed using the JPEG or GIF techniques can be delivered to the requestor via a browser in a manner that is both straightforward and transparent. However, some forms of data cannot be compressed using lossy techniques while still remaining usable. Text is one such data type, as are x-rays. Compression techniques in which no data is lost are referred to as lossless. The popular PK zip technique is an example of a lossless compression technique.

An individual who wishes to retrieve information from the Internet most typically connects to the Internet through an Internet Service Provider (ISP) by using one of numerous types of connections that are available for that purpose such as Digital Subscriber Lines (DSL), Cable, or Integrated Services Digital Network (ISDN). The speed with which the user can download information from the Internet is determined by the bandwidth of the connection. As is understood in the art, bandwidth is the amount of data that can be transmitted in a fixed amount of time. As multimedia grows in popularity and visual representations become the norm, the availability of adequate bandwidth is strained and the delivery capability of existing data infrastructures is slowed or overwhelmed. Commercial connections such as T1 and T3 lines offer fast delivery of content to the user by greatly increasing the available bandwidth. However, such connections are not economically feasible for most users.

Groups of users requesting the same content benefit from the improved performance provided by Proxy Servers. Proxy Servers save the results of requests for information made by all users. As a result, a request for information that has been cached is returned by the Proxy Server instead of necessitating that the request travel to the original source for the information. Accordingly, time in delivering requested content could be greatly reduced by the appropriate use of intermediate Proxy Servers. Several Proxy Servers exist that can be custom configured to enhance delivery of content. Jigsaw is an example of such a Proxy Server.

Various compression techniques, Proxy Servers, and caching routines interact to form a patchwork that delivers content to the requesters. However, because of the increased demand for content, the current state of the art devours bandwidth capacity and slows delivery of such content to the requesters of information, thus creating a need for improved methods of content delivery from the Internet to the user.

Reference is now made to FIG. 1 of the Drawings, wherein a conventional network is illustrated, depicting one example of the state of the art. As illustrated in the figure, content providers 110 provide content to the ISPs, LANs and/or WANs (collectively designated by the reference numeral 120) through the Internet 130. As is understood in this area, the content being provided via the Internet 130 requires large bandwidth (generally represented by the reference numeral 135), which consumes valuable resources. This content is further provided to a number of respective Internet users 140 connected to the ISPs, LANs and/or WANs 120 with typically slow connections (generally represented by the reference numeral 145). These slow connections 145 and the inefficiency of content delivery to the ISPs do not allow the Internet users 140 to receive the content efficiently, hence, all the bandwidth dedicated to the user is consumed.

As indicated, an Internet user 140 wishing to download content from one of the content providers 110 via the Internet will be provided the content through the ISP, LAN or WAN 120 server. The content is provided “as is” without any efficiency in its delivery, e.g., whenever the user browses a web page which has already been viewed before, all the content within that page needs to be downloaded again. This creates inefficiency by redundantly downloading the same content.

There is, therefore, clearly a need to conserve bandwidth resources by, for example, better utilizing or reducing the required content downloaded from web servers 110 by the ISP 120. Faster, more efficient user connections to the web servers are needed to ease the web browsing process of Internet users, thereby making the subjective experience of surfing the web and visiting websites more enjoyable.

### SUMMARY OF THE INVENTION

The present invention is directed to a system, method and apparatus relating to the delivery of content from a computer network, the delivery of such content having been speed-enhanced by editing and compression. In other words the content delivery provided by the invention provides the user with faster downloading of requested content, while at the same time ensuring that the requested content has retained its essential characteristics.

A first embodiment of the present invention provides a method, system and apparatus for delivering content to a requester at a personal computer or workstation from the Optimal Content Delivery System (OCDS) network. The requestor makes a content delivery request through the network to the OCDS network distribution/control server, which checks to see if the requested material exists in an edited and compressed format in the OCDS cache. If the content exists in the OCDS cache in a compressed and edited format, this content is retrieved and delivered to the requester where it is decompressed by the requester. However, if the content is not available in an edited and/or compressed form, the OCDS makes a request to a remote computer/network, which has the content and retrieves such content for compression and editing. The distribution server compresses and edits the content, if possible, and delivers the content to the requester where it is decompressed. Content can be delivered to the requester in its original format (uncompression and/or unedited)if the compression and/or edit functions cannot be performed.

A second embodiment of the present invention provides a method, system and apparatus for delivering content from a web server to a requester through the OCDS network. The OCDS intercepts the requests made to the web server before reaching the web server. The OCDS network, in this embodiment, protects and shields the web servers from external networks. Thus, any access to the web servers is performed through the OCDS network. The distribution server retrieves the requested content from a single location (web server) if the content does not exist in the OCDS cache in an edited and/or compressed format. The distribution server upon receiving a request checks to see if the requested content already exists in an edited and/or compressed form in the OCDS cache. If the content is available in the cache, it is delivered to the requested where it is decompressed. However, if the content is not available in the OCDS cache, a request is made by the distribution server to the web server to serve the requested content. Upon receiving the content by the distribution server, the content is edited and/or compressed and delivered to the requester. If the content cannot be edited and/or compressed, the content is delivered in its original form.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 illustrates a conventional content distribution system wherein content providers provide content to ISPs, LANs, and/or WANs through the Internet;

FIG. 2 illustrates a content distribution system according to a preferred embodiment of the present invention in which content provision from content providers to ISPs, LANs and/or WANs through the Internet is improved;

FIG. 3 illustrates interoperation of several network servers in a preferred embodiment of the present invention;

FIG. 4 illustrates an overview diagram of the components of the invention with Editor according to one embodiment of the invention;

FIG. 5 illustrates a diagram of the components of the invention with Scanner according to a further embodiment of the invention;

FIG. 6 illustrates an overview diagram of components assembled on Distribution/Control Servers according to a further embodiment of the invention;

FIG. 7 illustrates a flowchart for an exemplary method for a control/distribution server in accordance with the teachings of the present invention;

FIG. 8 illustrates an additional flowchart for an exemplary method for a Hyper Text Markup Language (HTML) edit server in accordance with the teachings of the present invention;

FIG. 9 illustrates another flowchart for an exemplary method for a compression server in accordance with the principles of the present invention;

FIG. 10 illustrates still another flowchart for an exemplary method for an N-depth compression server in accordance with the principles of the present invention;

FIG. 11 illustrates a flowchart for an exemplary method for a list/cache manager in accordance with the teachings of the present invention;

FIG. 12 illustrates a diagram showing a general description of the steps used to create a compressed image within the content delivery system as well as the attributes of the resulting “.trans” image;

FIG. 13 illustrates a diagram of the Proxy Client according to an embodiment of the invention;

FIG. 14 illustrates an overview diagram of the Plugin according to an embodiment of the invention; and

FIG. 15 illustrates a diagram of the internal workflow of the plugin according to an embodiment of the invention.

### DETAILED DESCRIPTION OF THE PRESENTLY PREFERRED EXEMPLARY EMBODIMENTS

The following description is presented to enable any person skilled in the art to make and use the invention. For purposes of explanation, specific nomenclature is set forth to provide a thorough understanding of the present invention. However, it will be apparent to one skilled in the art that these specific details are not necessarily required to practice the invention, and descriptions of specific applications are provided only as examples. Various modifications to the preferred embodiments will be readily apparent to one skilled in the art, and the general principles defined herein may be applied to other embodiments and applications without departing from the intent and scope of the invention. In other words, the present invention is not intended to be limited to the exact embodiments shown, but is instead to be accorded the widest possible scope consistent with the principles and features disclosed herein.

The present invention relates to a content delivery system and more particularly to the retrieval of information that has been optimized for delivery through editing and compression. The Optimal Content Delivery System (OCDS) editing and compression services provided to the requesters utilize a Proxy system, a compression algorithm, proprietary editor (or scanner) and proprietary client/plugin to seamlessly deliver content from the Internet or Intranet to the requestor. For the sake of description the acronym OCDS has been used to designate an embodiment of the invention as a system as well as an embodiment of the invention as a system operating from a private network.

The delivery system utilizes a compression algorithm which is capable of compressing both lossy and lossless information. Through an editing and a caching process, the requester is able to receive requested content much faster than would be the case without the advantages of the invention, especially on subsequent requests for the initial content.

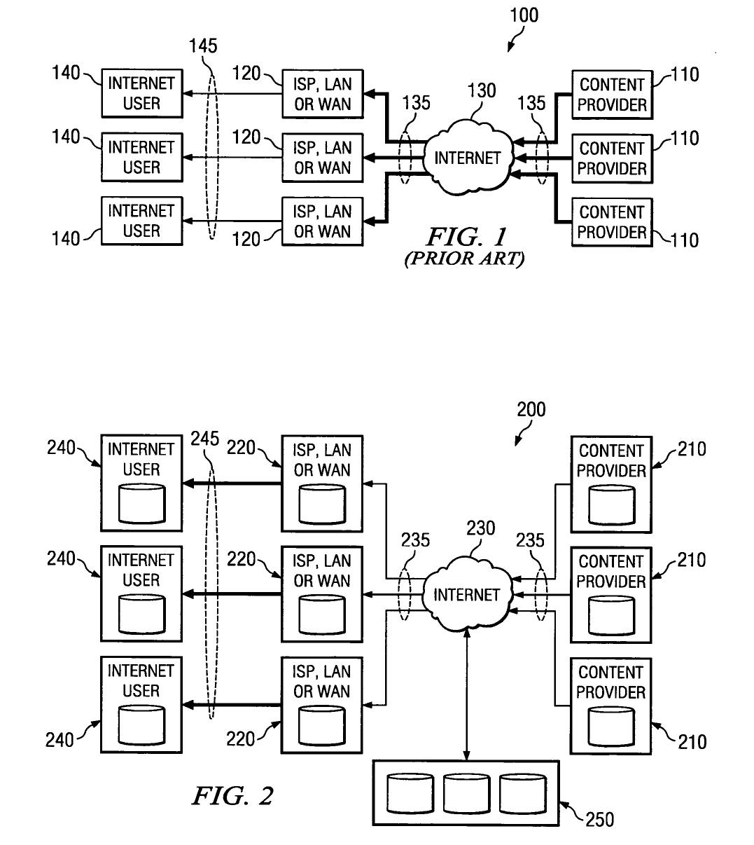

With reference now to FIG. 2 of the Drawings, there is illustrated a content distribution system (generally designated by the reference numeral 200) according to a preferred embodiment of the present invention. As shown in FIG. 2, content is provided from a number of content providers 210 to the ISPs, LANs and/or WANs (collectively designated by the reference numeral 220) through the Internet 230, as also shown in connection with FIG. 1. However, in this embodiment, the content being provided is intercepted at an intercept point (generally designated by the reference numeral 250), compressed, edited and cached therein. Although the intercept point 250 is shown separate and distinct from the source content providers 210 and designation nodes 220, it should, of course, be understood that the intercept point 250 may also be conterminous with either the nodes 210 or the nodes 220 and may be located anywhere along the content travel path 235. By virtue of compressing, editing and caching frequently downloaded content in the manner of the present invention, Internet users 240 experience a significant increase in bandwidth and faster connections. The service providers 220 witness reduction in incoming network traffic due to the caching nature of the interception point or content distribution system 250, thus resulting in large bandwidth savings.

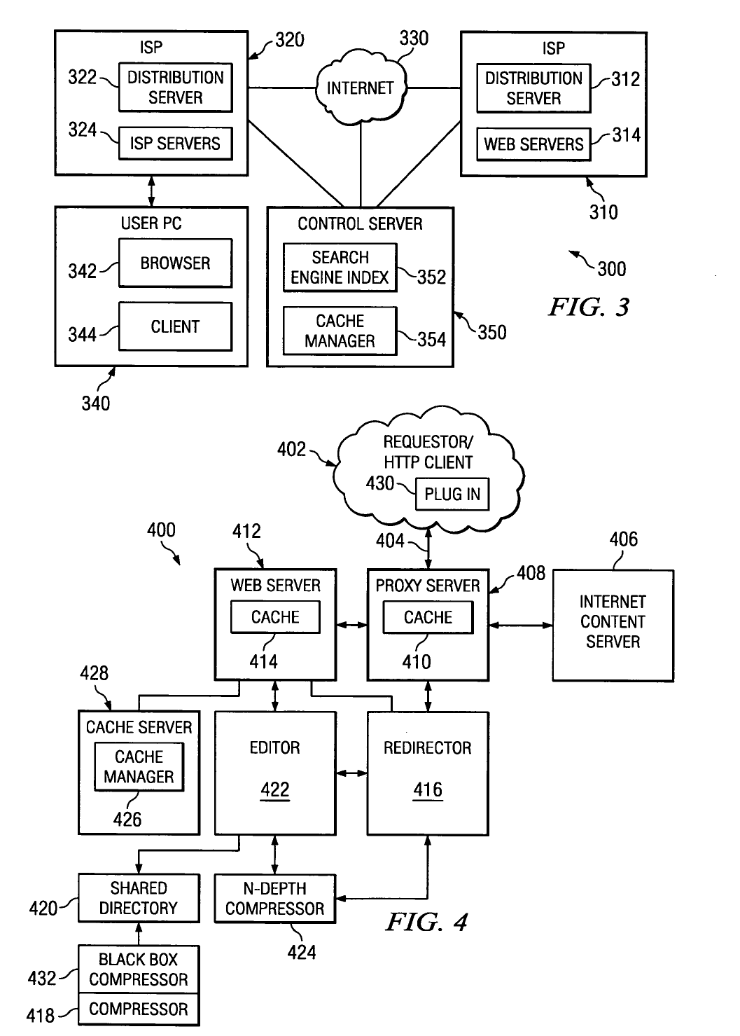

FIG. 3 illustrates a preferred embodiment of the present invention and preferred interoperation of the network elements (generally designated collectively by the reference numeral 300) in a typical sequence of events. It should, however, be understood that numerous scenarios can occur using the same network element configuration and/or variations of the order of events without departing from the principles of the present invention. In particular, a user 340 first initiates a request, e.g., a Hypertext Transfer Protocol (HTTP) request, with a browser 342 by requesting a web page or a Uniform Resource Locator (URL). The request may be routed directly to a distribution server 322 in an ISP 320 or to an ISP server 324 therein and then to the distribution server 322, using a client application 344 in the user/requester PC 340 or browser 342. The client application 344, before sending the request, tries to fill the request from the local cache in the user PC or client terminal 340 before using the network. The client application 344 preferably checks the header information of the compressed content in its cache to determine whether the content needs updating before being used. However, if the content requested is not in the client's terminal cache or has expired (needs updating), the request is sent to the distribution server 322 of the ISP 320. The distribution server 322 tries to fill the request from the cache manager, and if the content is present and current, the compressed or uncompressed content is provided to the user; otherwise, the distribution server 322 tries to get the content from a control server 350. The control server 350 also checks for the requested content in the cache, and if the content is available and current, it is served to the user through the distribution server 322.

The control server 350 maintains a list or index 352 of recently used URLs and header information of the URLs in order to keep the content up-to-date before being served to the user. When the content is served to the user through the distribution server 322, it is compressed and cached in the distribution server 322. Thus, if requested again, will be accessed from the distribution server 322. If the content is not available in a cache manager 354 accessible by the control server 350, it is filled from the Internet 330.

The control server 350 receives, compresses, and indexes the requested content, so that the content is available the next time it is requested. Alternatively, if the content is not available in the control server 350, the distribution server 322 makes a request to receive the content from the Internet 330. Upon receiving the original content, the distribution server serves the content to the user “as is”, then compresses and stores the content in the cache so it is available the next time it is requested. The content received from the Internet 330 can optionally be received from another distribution server 312 acting as a proxy for a group of web servers 314. In this instance, the content provided by the second distribution server 312 acting as a web server 314 is served compressed, hence, content will be provided compressed to the user the first time it is requested. Similarly, as mentioned above, if the content is not available in the web server 314, it is provided from the Internet 330 using the original format of the content to the user 340. As will be explained and made clear hereinafter, content may be served edited and compressed the first time requested even if the content is not available in a local cache, in this case, the distribution server compresses and edits the content in realtime.

FIG. 4 illustrates an overview diagram of the components of the OCD system 400 with Editor according to one embodiment of the invention. In this representation the components of the Distribution/Control Servers are shown separately. However, as is known by those who are skilled in the art, many of these components can be combined in such a way that they can be deployed on far fewer servers. OCDS includes a Proxy Server 408 that is connected to the Internet. The Proxy Server 408 is able to intercept requests from certain Hypertext Transfer Protocol (HTTP) Clients 402, such interception made possible because of the Proxy's logical location between the HTTP Clients 402 and the Internet Content Server 406 serving the requested content. Additionally, the Proxy Server is connected to the Redirector 416, which in turn is connected to the n-Depth Compressor 424 and to the Editor 422. The Editor 422 is connected to the Compressor (the Compression Server) 418 with which it shares a read write directory 420.

The requester, shown as the HTTP Client 402, makes a request 404 for information from the Internet Content Server 406. The Proxy Server 408 intercepts the request and forwards the request to the Redirector 416. The Redirector 416 checks to see if an edited compressed version of the content is available locally. If an edited and compressed version of the content is available locally then the URL is returned to the Proxy Server 408. The Proxy Server 408 then fetches the URL from the Web Servers Cache 414 and sends the edited and compressed content to the requester where it is viewed with a browser having a Plugin 430. However, if the edited and compressed URL exists in the Proxy's Cache 410 the fetch routine is bypassed and the edited and compressed content is returned to the requester 402.

In the event that the requested content is not locally available, the Redirector 416 notifies the Proxy Server 408 to obtain the URL from the source, notifies the Editor 422 that a page needs editing and notifies the n-Depth Compressor 424 to perform n-Depth Compression. The Proxy Server 408 fetches the URL from the Internet Content Server 406 on the Internet and returns the original unedited page to the Requestor 402. The Editor 422 checks the page's HTML code for tags which designate objects, such as Anchor tags HREFs and image SRCs having the appropriate extensions such as GIF, JPEG and (Portable Network Graphics (PNG) that can be compressed and replaced with compressed content tags. Once the editing is complete the edited tags and images will reflect proprietary image type “.trans”.

The Editor 422 gathers the image source URLs into a list along with their location and then submits them for compression at compressor 418. The compressor 418 is, by way of example but not limited to, a JAVA application that is responsible for pacing the Black Box Compressor 432. The Black Box Compressor 432 provides a corresponding JAVA native common interface to the compressors 418 and may support 1 to n compressor server 418. The actual image files to be compressed are placed in a directory 420 that is equally writeable by both the Editor 422 and the Compression Server 418. The Editor 422 writes the image file to the compression directory 420 using a temporary name. The Compression Server 418 then causes the Black Box Compressor 432 to create a new file with the “.trans” extension in the compression directory. Based on the success of the compression, the Editor 422 moves the edited and compressed URLS to the Web Server cache 414 where they are available for delivery on subsequent requests. Simultaneously with the actions described above the n-Depth Compressor 424 acting upon notification from the Redirector 416 parses out all of the links in the requested URL and sends the links that can be edited to the Editor 422. These URLs are edited, compressed, and placed in the Web Server cache. The depth of this pre-fetching is configurable. Requests subsequent to an unedited page being returned to the requester will be delivered from the cache in an edited and compressed form, thereby greatly increasing the speed as well as continuity of content delivery.

The Cache Manager 426 is, by way of example, a JAVA object that handles interfacing with the Web Server cache 414. Entries in the cache are hashed using a Cyclic Redundancy Check (CRC) algorithm, e.g., by calculating the Adler32 checksum of the characters in the URL. This provides 8 hexadecimal digits for forming a two-tier directory structure for each file. The original file extension is preserved for ease in identifying the contents of the file.

The Cache Server 428 is a C++ application that runs periodically to check the Web Server cache 414. The Cache Server 428 uses a URL sorting algorithm and high- and low-watermark hysteresis to maintain the most active edited pages in the Web Server cache 414. Because the Proxy Server 408 also caches these pages once they have been requested, some duplication of disk space is unavoidable. However, by utilizing the Internet Cache Protocol (ICP) supported by the Proxy Server 408, the Redirector 416 can make use of the Proxy's cache 410 as well as the Web Server's cache 414.

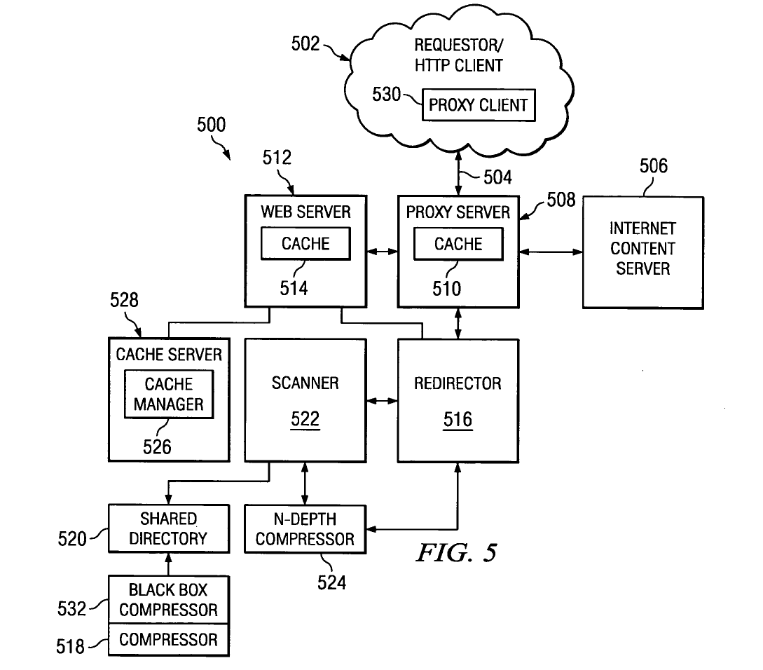

FIG. 5 is a diagram of the components of the invention with Scanner according to an alternative embodiment of the invention 500. The critical difference between this diagram and the diagram of FIG. 4 is the replacement of the Editor with a Scanner. The Scanner 522 scans uncompressed requested pages for those that can be compressed and submits such pages to the Compressor. The scanner interoperates with the components of the network in a similar manner as does the editor described with reference to FIG. 4. However, using the scanner, the content/pages are only scanned to be identified if it needs compression or not. The content/pages are not edited but are only compressed and stored. The components of the network, in this embodiment, function in a similar fashion as described with reference to the embodiment of FIG. 4.

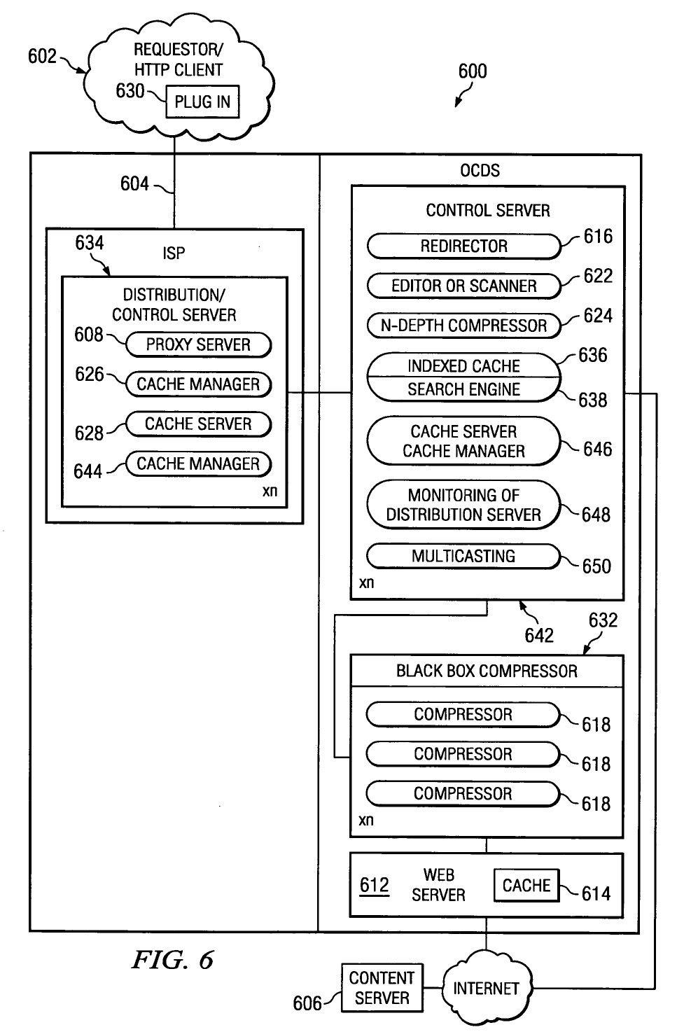

FIG. 6 illustrates an overview diagram of components assembled on Distribution/Control Servers according to an alternative embodiment of the invention. Certain functions contained on servers in FIG. 6 retain the same functions as illustrated and set out in FIG. 4. For example, the Proxy Server function illustrated in FIG. 6 608 is the same function shown by Proxy Serve 408 in FIG. 4. Names and designations of elements between FIGS. 4 and 6 have generally been kept symmetrical so that one may refer back and forth between component descriptions where applicable. In this embodiment of the invention, Distribution/Control Server(s) 634 may reside on separate networks from the Control Server(s) and Compression Server(s) thereby acting as subsets of the Control Server 642. The Control Server 642 permits the Distribution/Control Servers 634 to share compressed content, thereby increasing the cache hit rate of the Distribution/Control Servers 634 by allowing the Distribution/Control Servers 634 to access the Control Servers' 642 content, in effect increasing the size of the compressed content cache.

The requester, shown as the HTTP Client 602 makes a request 604 for information from a Content Server on the Internet 606. The Proxy Server 608 residing on a Distribution/Control Server 634 intercepts the request and forwards the request to the Redirector 616. If an edited and compressed version of the content is available locally then the URL is returned to the Proxy Server 608 which either fetches the URL from the Web Servers' Cache 614 and sends the edited and compressed content to the requestor where it is viewed with a browser having a Plugin 630. However, if the Edited and Compressed URL exists in the Cache Server 628, the Proxy Server 608 bypasses the fetch routine and returns the edited and compressed content to the requester. In the event that the request is not available locally, a request is sent from the Distribution/Control Server 634 to the Control Server 642 for the requested content. The Control Server 642 allows Distribution/Control Servers 634 to access the Control Server's cache 636, thereby increasing the size of the network of compressed content. The Control Server's cache 636 is indexed with an associated Search Engine 638 to allow for searching of content or sites. URLs may be submitted to the Control Server 642 to be compressed, cached, indexed and stored in compressed or original form, or both. When the Distribution/Control Server(s) 634 make requests or submit URLs for n-depth compression 624 caching and indexing 636 may take place depending on the content. In the event that the Control Server 642 does not have a cached copy of the to content available, such content will be retrieved from the Content Server 640 on the Internet and may be sent back to the requestor 602 the first time in an uncompressed format. The requested content is contemporaneously edited, compressed, cached and placed in the Web Server's cache 614. Thus upon subsequent requests the Proxy Server 608 may retrieve and deliver the previously cached compressed content to the requester 602. The control server may be connected to the Internet and the distribution server, and can be accessed through either of the two connections. The main function of the control server is to allow distribution servers, described hereinafter in detail, to share and access compressed content. The control server can be used to update software and to update the cache manager of the distribution servers. The control server can also be used to monitor the distribution servers' activity, generate reports, and transfer the compressed content to increase bandwidth. As mentioned herein, the control server can be used as an alternate route for providing content in the network in order to increase reliability. The control server also performs a form of multicasting by accepting subscriptions from distribution servers for multicast, and sending data to the distribution servers. The distribution servers then buffer the content in their cache and distribute it to their clients that have made multicasts requests.

The distribution server has a connection with the Internet and a direct connection with the control server and other distribution servers. The distribution server is capable of compressing content and retrieving compressed content from other distribution servers or from the control server. The distribution server maintains a large cached content which is optionally compressed by a “black box” compressor, described hereinafter. The compression of the content is performed to save valuable bandwidth in communicating with a user upon a content delivery request. Distribution servers, in addition to having the capability of requesting content from the control server and the Internet, have the capability of requesting content from other distribution servers, not explicitly shown in the Figures. Each distribution server has access to all the public content in the network. If the content requested by the distribution server is present in another distribution server, the content is delivered compressed and will be provided in compressed form the first time it is requested by the user. Optionally, the distribution servers can function without the compression and edit functionalities, instead retrieving the compressed content from the control server or from other distribution servers that have compression and edit capability. The distribution servers communicate with users using a variety of network protocols and can be configured using web browser forms, applets and/or configuration files. Content can be delivered to a particular user or to a group of users in a predefined format according to the preferences of the user or group of users.

The distribution server has features and properties that are similar to the control server, described hereinabove, and the stealth distribution server, described hereinafter. The stealth/distribution/control servers support both secure and insecure Hypertext Transfer Protocol (HTTP/HTTPS) . As with other protocols, the support for the HTTP will be in an object factory scheme, thus allowing new versions to be plugged in when needed. In addition, the stealth/distribution/control servers may support NEWS, FTP and/or MAIL in a factory formatting, so that newer versions may be plugged in when needed. The servers may also support standard mime and other data types, preferably through object factories so that new types may be added later. Servlets and Common Gateway Interface (CGI) may be supported by the web server object so that functionality may be added.

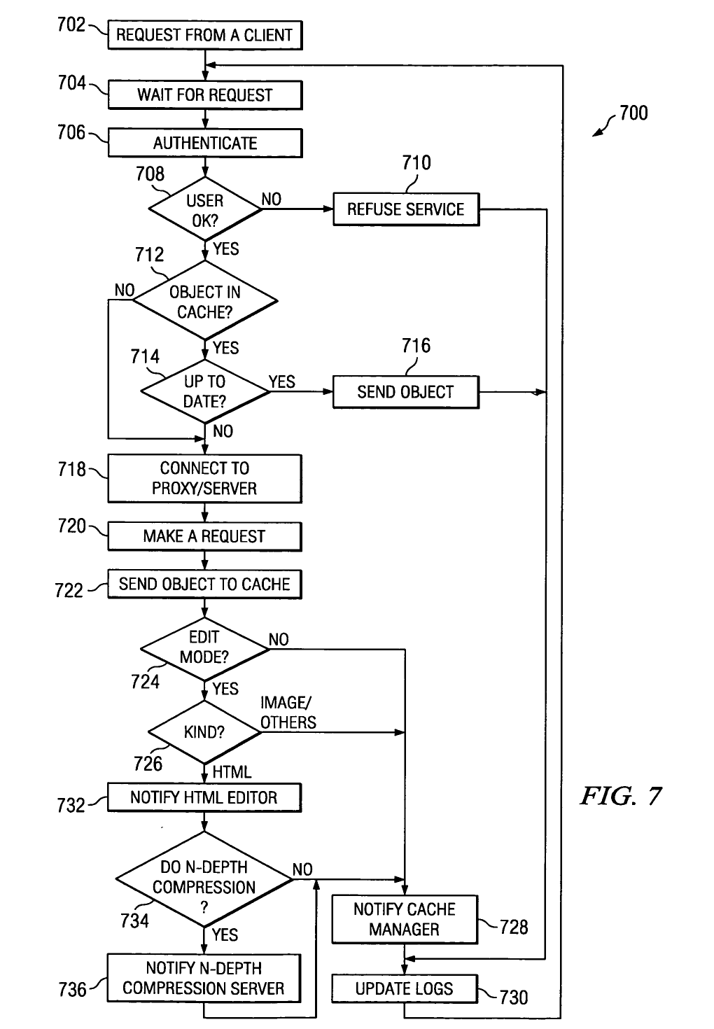

FIG. 7 illustrates an exemplary method in flowchart form for the control/distribution server of the present invention. The client, sometimes referred to as user or client terminal, sends a request to the control/distribution server (702), which authenticates the request(706). If the client is allowed to utilize Lathe control/distribution server (708), the process continues as described hereinbelow, otherwise, service is refused (710). The control/distribution server checks for the object in the cache (712). If the object requested is in the cache and is up to date (714), it is sent to the client (716). If the object is not in the cache (712) or is not up to date (714), the control/distribution server connects to the proxy server (718) to make the request for the object (720). The object is sent to the distribution server and to its cache (722). The distribution server also checks whether the edit mode is activated (724). If the edit mode is enabled, the server checks the content (726). If the content is an image or other media, the cache manager is notified (728) and the logs are updated (730). However, if the object is HTML content, the HTML editor is notified (732) and the N-depth compression server is notified, which performs an N-depth compression on the HTML document (734). The cache manager is notified of the procedure (728) and the logs are updated (730).

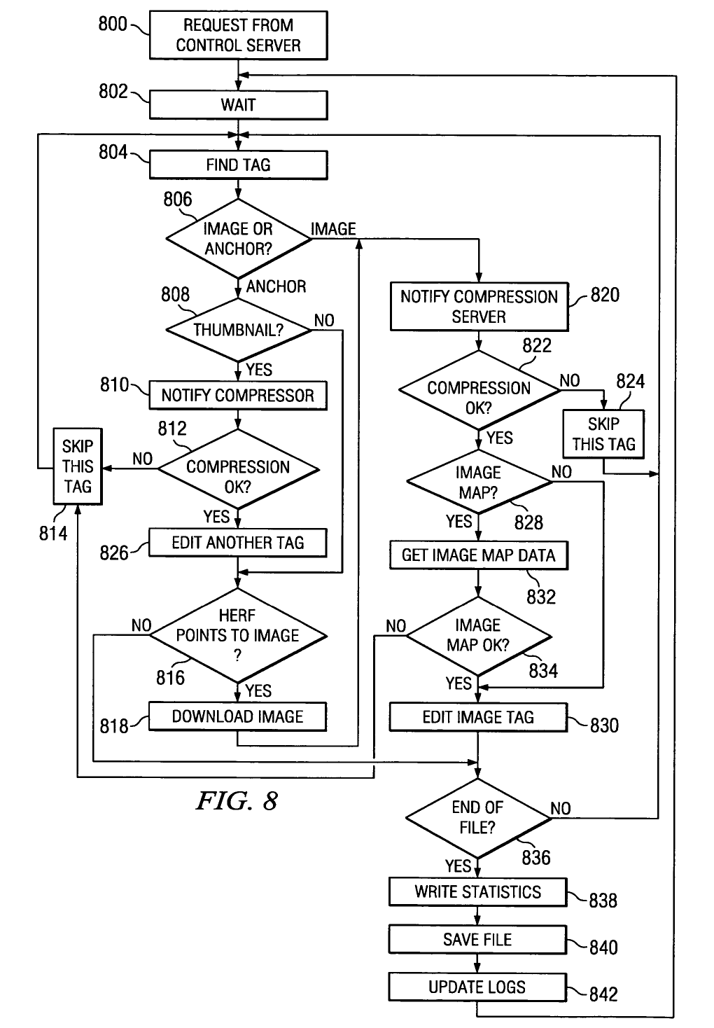

The HTML edit server connected to the distribution server and to the compression server modifies web pages so that the pages reflect the changes needed to display compressed content in a user browser. The edit server includes both SGML and control language edit servers. The edit server may optionally work with distribution servers, control servers, cache managers, and/or compression servers to compose a compressed URL object. The edit server, sometimes referred to as the HTML edit server, communicates with and may be controlled by the distribution/control server through sockets and RMI using a control object. As will be explained later with respect to FIG. 8, the edit server parses and edits HTML pages. The edit server also supports HTML, XML and Javascript in preferably an object factory scheme, allowing new HTML, XML and Javascript to be plugged in when needed. The editing will be performed to replace the existing content tags with compressed content tags. Anchor “<a” and image “<img” tags are examples of tags that need to be modified. These tags will be replaced with “<embed” tags. Also, parameters inside the tag needs to be modified to reflect the tag modification. Therefore, tags pointing to images are replaced by tags pointing to embedded objects. For example, “<img src=myimage.jpg width=100height=100>” will be replaced with “<embed type=x-image/XXXX/trans src=myimage.jpg.trans width=100 height=100>.” The x in the x-image mime means that it is not a registered mime type.

An important distinction to notice in the new tag is that an additional extension is added to the image name. This is performed to avoid confusion caused by replacing the original extension of the image. This is important if two images in the same URL have the same name but different extensions. Therefore, an additional extension is appended to the compressed image name and extension. This process is explained in detail hereinafter. This compressed image resides on the local servers and not in the original server.

For clients with handheld devices such as a personal digital assistant (PDA) or a wireless phone capable of receiving content, the edit server may output text-only versions of HTML pages. The images may be replaced with tables, image description and/or text resulting from an image reformatting. Images may optionally be downsampled and left in the page for more advanced handheld devices capable of receiving and displaying the images.

For the edit server, a web manager who does not want a certain web page or a web site to be compressed simply uses a standard meta tag specification to inform the server not to process selected pages from the web site or even the entire content from that web site.

FIG. 8 illustrates an exemplary method in flowchart form for the HTML edit server of a preferred embodiment of the present invention. The editing process is performed in conjunction with the Compressor 418, 618 and the Control Server 642 or the Redirector 416. The process flows from a “wait state” 802 to processing once a request is received. When a request is received, the HTML Editor checks the submitted page's HTML code for tags, 804 which designate objects, such as GIF, JPEG and PNG, that can be compressed and replaced with compressed content tags. If the tag is found to be an image tag at 806 then the Compressor is notified that an image needs compression 820. If the compression was unsuccessful the tag is skipped 824 and the Editor resumes the process of finding and examining new tags for compression 804. If the compression was successful the image tag is edited 830, the end of the file is reached 836, statistics are written 838, the file is saved 840, the logs are updated 842 and the Editor goes back into the wait state 802.

If the tag is found to be an Anchor Tag or a Thumbnail 808 then the editor notifies the Compressor that an image needs compression 810. If the compression is unsuccessful the tag is skipped 814 and the editor resumes the process of finding and examining new tags for compression 804. If the compression was successful the Anchor tag is edited, the end of the file is reached 836, statistics are written 838, the file is saved 840, the logs are updated 842 and the Editor goes back into the wait state 802.

On the other hand if the tag is a HREF that points to an image 816, the image is downloaded 818 and the Compressor is notified that an image needs compression 820. If the compression was unsuccessful the tag is skipped 824 and the Editor resumes the process of finding wand examining new tags for compression 804. If the compression of the image tag was successful, the end of the file is reached, statistics are written 838, the file is saved 840, the logs are updated 842 and the Editor goes back into the wait state 802.

At step 828, the Editor checks for an image map. If an image map is found then the Editor gets the image map data 832. If the compression is successful the Image Map is edited 830, the end of the file is reached 836, statistics are written 838, the file is saved 840, the logs are updated 842 and the Editor goes back into the wait state 802. If an image map is not found the image tag, if any, is edited 830 the end of the file is reached 836, statistics are written 838, the file is saved 840, the logs are updated 842 and the Editor goes back into the wait state 802.

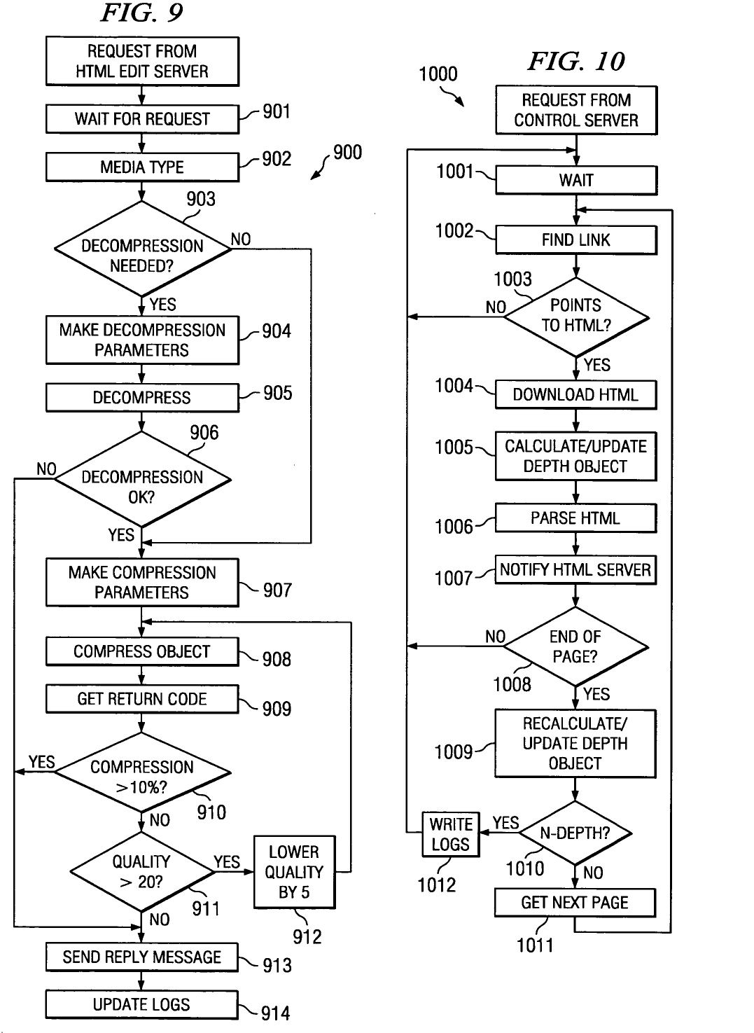

FIG. 9 illustrates an exemplary method in flowchart form for the compression server according to an embodiment of the invention. Compression is preformed by the Compressor 418, 618 and the HTML editor. Initially the Compressor is in a wait state until it gets a request from the HTML Editor 901. Upon receiving a request to compress an image, the Compressor first determines the media type 902 of the material to be compressed (JPEG and GIF files are examples of media types that can be compressed). The decision block next determines whether or not the media type must first be decompressed 903. Certain types of media such as JPEG and GIF must be decompressed before the Compressor can compress them. If there are images that need to be decompressed then decompression parameters are set 904 and the image is decompressed 905. In the case of JPEG and GIF the decompressed image becomes a BMP (bitmap). The Compressor checks to see if the decompression was successful 906. If the decompression was successful then the Compressor sets the compression parameters 907 and compresses the object 908. A return code is generated 909 and the compression is checked to see if such compression was more than predetermined threshold (e.g., 10%) 910. If the compression was more than the threshold, a reply message is sent to the Editor stating that the compression was successful 913. The logs are then updated 914, ending compression for this object. If the compression was less then threshold the quality is checked and a determination is made as to whether or not the quality is greater than another predetermined threshold (e.g.,>20) 911. If the quality is >20 it is lowered by a predetermined amount (e.g., 5), 912 and the object is recompressed 908. If the quality is less than the threshold (<20), a reply message is sent to the Editor that the compression is complete. The logs are updated 914, thus ending the compression for this object. In the instance that the decompression is not successful 906, a reply message is sent to the Editor stating that the decompression was unsuccessful 913. The logs are updated 914, thereby ending compression for this object. FIG. 10 illustrates a flowchart of n-Depth Compression 1000 according to an embodiment of the invention. The n-Depth Compressor, working in concert with the Control Server 632 and the HTML Editor 423, parses out links from requested URLs and sends the resulting pages to the HTML Editor. The depth of such parsing is configurable at startup. The following description of FIG. 10 illustrates the n-Depth Compression processes. The n-depth Compressor begins in a wait state 1001 until it receives a request from the Control Server or Redirector to examine a URL for links. Upon receiving a request to examine a URL, the n-Depth Compressor locates the first link on the page 1002 and a decision block 1003 determines if the link points to a page coded with HTML. The HTML encoded page is downloaded 1004. The depths of the associated links are calculated and the depth object is updated 1005. The HTML is then parsed 1006 and all images are downloaded =using a separate thread 1006 and the Editor and Cache Manage are notified 1007. Next, the Editor is notified that it needs to edit the page and then checks with the cache manager to see if it already has the page. A decision block 1008 determines whether are not the end of the page has been reached. If the end of the page has been reached, depth is recalculated and the depth object (data structure that tells the n-Depth Compressor how deep it is) is updated 1009. If the end of the page has not been reached the routine begins again 1002 with the next link. After reaching the end of the page 1008 and recalculating depth and updating the depth object 1009, a decision block 1010 determines whether or not n-Depth has been reached. If n-Depth has been reached the log files 1011 are updated and the n-Depth Compressor returns to wait 1001. In the event that a first link is not found the n-depth Compressor looks for a second link by returning to 1002.

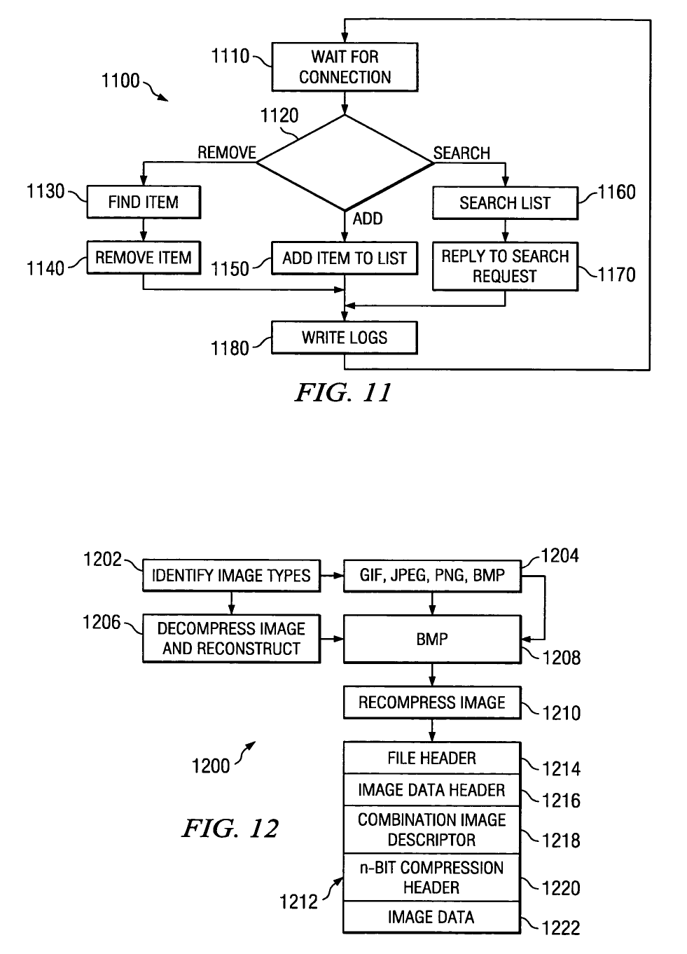

FIG. 11 illustrates an exemplary method in flowchart form for the list/cache manager. The cache manager usually waits for a connection (1110) and determines the request nature (1120) e.g., removing, adding or searching. If the item needs to be removed, the item is first found (1130) and then removed (1140). If the item needs to be added, it is added (1150). If the item needs to be found, the current list is searched (1160) and a reply is generated for the search request (1170). The list is updated in any of the three requests and a log file is generated (1180).

The stealth distribution server has the same functionalities as a distribution server in addition to other functionalities, mentioned herein. The stealth distribution server accepts content delivery requests and creates new requests to retrieve data. Similar to the distribution server, the stealth distribution server supports all the standard proxy server features and the editing and compression techniques discussed in the present invention. The difference between the stealth distribution server and the distribution server include two configuration settings, the option to be setup as a circuit proxy and the option to retrieve everything from a single address. The stealth distribution server uses three networks, one protected inside network, one outside network usually connected to the Internet, and an optional dedicated connection to the OCDS network. The stealth distribution server protects the inside server from the outside network and provides increased bandwidth. The stealth distribution server, while servicing the request for content delivery, protects the web server from outside networks. The stealth distribution server will also compress and cache content to increase the existing bandwidth, which is further enhanced by utilizing the dedicated connection to the OCDS network. Requestors requesting content from a web server will request the content from the stealth distribution server which will provide the content in a compressed form from its cache (database). If the content is not available in the stealth distribution server cache, the content is requested from the web server edited, compressed and cached. The content is then sent to the requestor and is also available in future requests by the same requester or any other requestor. Thus acting as a protecting firewall to the web server. Both the stealth distribution server and the distribution server, mentioned hereinbefore, may be configured to deliver realtime compressed content with the aid of a robot or over time once the content has been requested.

FIG. 12 is a diagram showing a general description of the steps used to create a compressed image within the instant content delivery system as well as the attributes of the resulting “.trans” image. “.trans” refers to the proprietary image type developed by Transfinity Corporation. The “.trans” image data is organized as byte streams consisting of data chunks that are read sequentially. Each file begins with header information consisting of a file header 1214 followed by an Image Data Header 1216, Combination Image Descriptor 1218, and an n-Bit Compression Header 1220. The image type may be either lossless or lossy or a combination of both types. This is made possible by the statistically based n-bit compressor. “.trans” supports true color from 2 to 32 bits a pixel as well as transparent key color. Grayscale is supported up to 16 bits per pixel. According to an embodiment of the invention the Scanner or the Editor first identifies an image type 1202. For example the image is identified as a BMP, JPEG or GIF 1204. After the image is identified it is decompressed 1206 and reconstructed back into its aboriginal type 1208. (Note that BMP is listed in step 1208 only by way of example). Thus an image identified as a GIF is decompressed and reconstructed back into a BMP or DIB image. The image is then compressed 1210 using a proprietary compression system such as the compression scheme in the co-pending U.S. patent application Ser. No. 09/631,368. Step 1212 illustrates the basic layout of a “.trans” image file. A file header 1214 begins each file and contains the following information. The first field, the identifier, is always “.trans”. The second field, tsize [1] is the size of the header itself. The third field, WORD offset [1], equals the number of bytes from this position of the beginning of the Image Data 1222. The fourth field, numimages[n] states the number of images in the file. “.trans” supports multiple images of multiple types thus facilitating the aforementioned proprietary n-Bit compression system, which may compress part of an image as “.trans” and compress other parts of an image in a different format (e.g. JPEG) . The fifth field, numloops[1], shows the number of loops an animated image will make. The sixth field shows the type of compression used in the image (e.g. JFIFjpeg/Huffman, BMP/n-bit). The filter type is set to 0 and the last field shows the compression ratio. Table 1 present the aforementioned information regarding fields in the file.

TABLE 1

| | |
|---|---|
| BYTE identifier[5] | /* Always “TRANS” */ |
| BYTE tsize[1] | /* Size of Transfinity file header */ |
| WORD offset[1] | /* Offset to image data */ |
| BYTE numimages[1] | /* Number of images */ |
| BYTE numloops[1] | /* Number of loops */ |
| BYTE type[1] | /* Compression type */ |
| BYTE filter[1] | /* Filter code */ |
| BYTE compressionratio[n] | /* compressionratio */ |

The second header is the image header, which contains 10 fields. The first field BYTE tsize[1] shows the size of the header, which is always 23 bytes. The second field DWORD isize[1] is the size of the compressed data in bytes. The third and fourth fields show the height and width of the image. The high and low transparency range of the image is shown by the fifth and sixth fields respectively DWORD thrange[1] and DWORD tlrange[1]. The seventh field WORD pause[1] determines the amount of time in 1/100ths of a second that the decoder should wait before continuing to process an animation. The eight field BYTE packed[1] Specifies what the decoder is to do after the image is displayed. The ninth field WORD cid size[1] is a variable and which is used to store the x and y attributes for animation. The last field is BYTE reserved[1] is used for background color information.

Table 2 presents the aforementioned information regarding fields in the image header.

TABLE 2
typedef struct imagedataheader
{

| | |
|---|---|
| BYTE tsize[1] | /* Size of image header */ |
| DWORD isize[1] | /* Size of image data */ |
| WORD width[1] | /* Width of image */ |
| WORD height[1] | /* Height of image */ |
| DWORD thrange[l] | /* Transparency range */ |
| DWORD tlrange[1] | /* Transparency range */ |
| WORD pause [1] | /* Hundredths of seconds to pause */ |

| | |
|---|---|
| BYTE packed[1] | /* Bit one is transparency flag */ |

| | |
|---|---|
| WORD cid_size[1] | /* Size of combination image descriptor */ |
| BYTE reserved[1] | /* Reserved */ |

} IMAGE DATAHEADER;

The Combination Image Descriptor follows the above described image header and contains an array of vectors, which mathematically describe the Image Data 1222. Some of the Image Data 1222 may be compressed as a lossy image type while other parts of the image may be compressed a lossless image type. WORD vectorArray[cid₁₃ size]. This field size is variable and is given in the cid size field. This is an array of vectors describing lossless portions of an image. The vectors always represent a rectangular area and each one is the coordinate for its place in the image.

The n-Bit Compression Header contains six fields and is always 10 bytes in size. The first field is the size of the n-bit header. The second field contains the size of the original file. Byte order is a number 0-20, which is the order of the starting statistics for the n-bit image compression. If the fourth field BYTE adaptive [1] is turned on then the starting order adjusts during compression to the optimal level. In other words the order statistics adapt to the data in the file and compress such data to the appropriate level. WORD mask[1] contains the block size of data that will be processed before the compression ratio is checked to see if the statistics need to be flushed.

Table 3 presents the aforementioned information regarding information in the n-Bit Compression Header.

TABLE 3

typedef struct nbitcompressionheader
{

| | |
|---|---|
| BYTE tsize[1] | /* Size of n-bit header */ |
| DWORD size[1] | /* Size of original file */ |
| BYTE order[1] | /* 0 thru 20 */ |
| BYTE adaptive[1] | /* 1 is on, 0 is off */ |
| WORD mask[1] | /* Block sizes */ |
| BYTE reserved[1] | /* Reserved */ |

} NBITCONPRESSIONHEADER;

Clients, represent the users of the content distribution system which may range from a simple plug to access the distribution network to a desktop version of the distribution server, with any number of variations in between. In a preferred embodiment, it may be preferable for clients to perform several functions, depending on the requirements. To perform these functions, clients may have plugins, applets, active X-components, Javascript components, HTML components and tags, client/server applications, proxies, winsock applications or services, firewall applications or servers, drivers, and/or other services. The basic functionality of a client 540 is to decompress the compressed content received from the content distribution servers and/or network. Clients may also have the capability to communicate with distribution servers through a variety of communication protocols in order to speed up data transfer, the ability to perform client/server functions, and the ability to perform other essential or optional features. Clients may have the capability to subscribe to media multicasts from distribution server, display the media from multicasts, perform proxy functions, perform firewall functions, and/or other capabilities depending on the equipment deployed. Clients may include personal computers (PCs), handheld devices, wireless phones, etc.

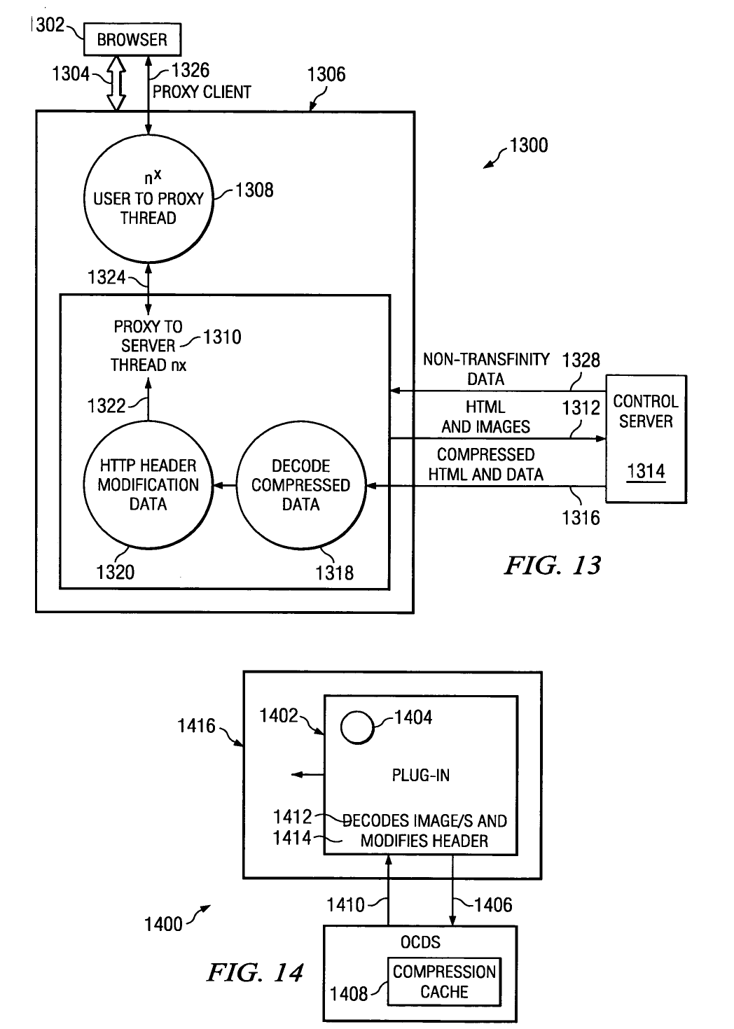

FIG. 13 illustrates a diagram of the Proxy Client 1300 according to an embodiment of the invention. The Proxy Client resides on the requestor's computer; such computer can be part of a network and configured as a workstation or can be communicating with a network through an ISP. The Proxy Client 1306 is multithreaded 1308, 1310 thereby allowing several actions to occur simultaneously. The requester makes a request 1304 through a browser 1302 to the network for information, such information being made up of HTML and Images 1312. The User To Proxy Threads 1308 transfer data to the Proxy Server Threads which carry the request to the Control Server 1314 to be compressed, cached, indexed and stored in compressed or original form, or both. The control server returns compressed HTML and compressed images (“.trans”) 1316 to the Proxy Client 1306 which then decodes the compressed data 1318, modifies the HTTP Header 1320 and passes the decompressed data back to the browser 1322, 1324, 1326. Step 1320 converts content type such as image/transfinity, which is inbound from the control server to image/gif or image/x-bitmap, PNG, or JPEG, and changes content length to uncompressed length. In some instances undecoded information is passed back to the browser 1328.

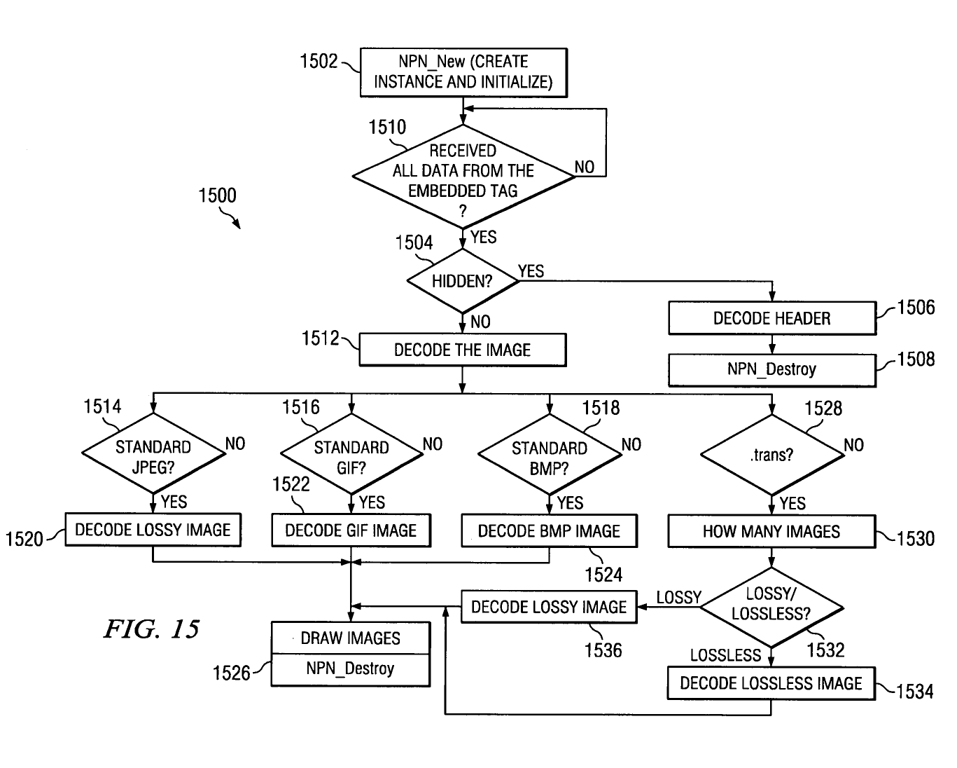

FIG. 14 is an overview diagram of the Plugin 1400 according to an embodiment of the invention. The Plugin resides on the requestor's computer; such computer can be part of a network and configured as a workstation or can be communicating with a network through an ISP. The Plugin 1402 is multithreaded 1404, thereby allowing several actions to occur simultaneously. The requester makes a request 1406 to a network for information, such information comprising, for example, HTML and Images. The request is processed compressed and placed in a cache 1408. The control server returns compressed HTML and compressed images (“.trans”) 1410 to the Plugin 1402 which then decodes the compressed data 1412, modifies the HTTP Header 1414 and passes the decompressed data back to the browser 1416. The actions of the plugin are more fully described in FIG. 15.

FIG. 15 is a diagram of the internal workflow of the plugin according to an embodiment of the invention. NPN_New Create Instance and Initialize 1502 begins operating when an embed tag whose type (image/Transfinity-trans) is received from the Control Server. The plugin extracts the SRC designator whose contents are “filename.gif.trans”. The original extension of the image is left as part of the SRC designator in order to prevent confusion on the part of the user. For example a given URL may have both a GIF and a JPEG of the same picture. Thus by leaving the original designation as part of the “.trans” image the user is able to differentiate between the original images. The Height and Width characteristic is also a part of the embedded information received by NPN_New Create Instance and Initialize. If such height and width information is not provided then Hidden=1/0 or True/False is required to continue processing the embed tag. If Hidden 1504 is returned, then a Javascript code snippet is placed into the requested page by the Editor which gets both height and width for the plugin to use in decoding the page and the image header is decoded 1506, and the stream ends at NPN-Destroy 1508. If all data from the Embed tag is received 1510 the images are decoded 1512. When standard image files are received 1514, 1516, 1518 then decoding proceeds as to image type 1520, 1522, 1524. Subsequent to decoding, the images are drawn 1526 and the stream ends. When “.trans” image files are received, the plugin first checks to see how many images are contained in the “.trans” image file 1530. It should be remembered that “.trans” image file can contain multiple images per file and that such images may be compressed either as lossy image types, lossless image types, or both. Subsequent to determining the number of images, the plugin then determines image type, 1532. If the image compression is lossless the plugin decodes the image 1534 then draws the image 1526 and the stream ends. If the image compression is lossy 1532 the plugin decodes the image 1536 then draws the image 1526 and the stream ends.

In a preferred embodiment of the present invention, content and/or data is served and retrieved with algorithms using combinations of filtering and buffered streams.

In a preferred embodiment of the present invention, distribution/control servers may be pre-loaded with URLs to be compressed. The user may submit URLs and/or personal bookmarks to be compressed. Log files from other servers which contain URLs to be compressed may be submitted to be compressed. In addition, a robot may be used by a network administrator to submit URLs. In general, web pages and content that are frequently accessed by users are preloaded and compressed for faster access in future events.

Distribution/control/stealth servers may optionally support dual networks by having one machine with two network cards. optionally, as mentioned with respect to the stealth distribution server, the control and/or the distribution server may be configured to retrieve all requested content from a single address. The memory caches residing within the distribution/stealth/control servers or those connected to the servers are preferably of configurable size, thus allowing room for expansion.

Security and privacy is achievable if desired in the present invention. The servers may support user accounts, so that each user may have bookmarks and other personal preferences which are secure from other users. The preferences, if needed, may be supported using user objects. URL encryption may be provided by the servers to provide an added security feature. Also, tunneling of content through dedicated connections can be used when appropriate for security and speed.

In a preferred embodiment of the present invention, servers may support multiple connections through the use of threads. However, thread priorities may be configurable and machine independent. The servers may use dynamic thread pools to manage the threads.

Upon completion of a process or task for a server, a log file is created. This log file may contain information regarding internal errors, file statistics, return error codes, compression statistics, user activity, and other required or optional information that is deemed valuable to be logged. The log files may have an HTML table format as well as a standard log format, so that they can be easily viewed with a browser.

The system, servers, and all other equipment, may be configured to self start in case of a severe problem, an abnormal operation, or normal maintenance operation. Thus when a crash to the system occurs, the system is able to restart.

Variations and editions of the content distribution system (CDS) should be understood to exist. The CDS may edit web pages, replace the content tags with embed or object tags, and/or modify the existing tags and compress the content. The editing may be performed automatically and require no interaction with web masters or server administrators. Another embodiment for the CDS is to compress everything including web pages, but not edit the pages. In both these cases, the content can be compressed in a background process and stored in a cache manager, and may be served from the cache manager the next time it is requested. The compressed content, using the embed tags, object tags, applet tags and/or new content tags causes the content to appear to the client that it is coming directly from the original server. Another preferred embodiment of the present invention provides all of the functionalities mentioned hereinabove, with the additional capability of compressing the content in realtime. In any of the embodiments mentioned hereinabove, the original content may be retrieved by sending a “no cache” request to the server, which tunnels the original content to the client.

The content distribution system of the present invention can be configured in a variety of ways, as should be understood by those skilled in the art, to perform various tasks. For example, one possible configuration may be a proxy for caching and compressing content for an ISP or LAN. Another task may be its use as a firewall for interpreting requests and serving up compressed content from an inner network of e-commerce and standard web servers.

The implementation of the aforementioned invention accomplishes high speed content delivery while saving bandwidth and other valuable resources in the network. This is achieved, as mentioned hereinabove, by using a compressed cache and delivering compressed content. The invention decreases the time needed to access an object at a server. The time needed to access an object at the server consists of the response time of the server plus the transmit time of the object. Thus, in slow connections where the transmit time is large, the network uses a lot of time for content delivery. However, if compressed caching is used in the network, the transmit time of frequently used objects is decreased. Hence, faster and more enjoyable content delivery is achieved with huge cost savings to the user and the network manager.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for delivering content to a first network, said method comprising the steps of:
receiving a request for content delivery from said first network;
searching for said content in compressed form in a cache;
retrieving said content in compressed form from said cache;
sending said content to said first network.

2. The method according to claim 1, further comprising, prior to said retrieving step, the steps of
retrieving said content in an uncompressed form from a second network;
compressing said content; and
storing said content in compressed form in said cache.

3. The method according to claim 1, further comprising the steps of:
editing said content; and
storing said edited content in said cache.

4. A method for increasing speed of content delivery to a terminal while conserving bandwidth, said method comprising the steps of:
sending a request for delivery of content from a first network;
checking, on a server in communication with said first network, for availability of said content in compressed form;
wherein if said content is available in said compressed form on said server, retrieving said content in said compressed form from a cache associated with said server and forwarding said content to said first network; and
wherein if said content is not available in said compressed form on said server, retrieving said content in an uncompressed form from a first node in communication with said server;
compressing said uncompressed content on said server; and
storing said content in said cache associated with said server in a compressed form, whereby said content is available upon a subsequent request from said first network.

5. The method according to claim 4, wherein said step of requesting further comprises the step of:
intercepting said request for content at a second node.

6. The method according to claim 4, further comprising the step of:
editing said uncompressed content.

7. The method according to claim 4, further comprising the step of:
determining if said uncompressed content can be compressed.

8. The method according to claim 7, further comprising the step of:
wherein, if said uncompressed content cannot be compressed, sending a null response to said first network; and
forwarding said uncompressed content to said first network.

9. The method according to claim 4, further comprising the step of:
sending the stored compressed content to said first network.

10. The method according to claim 4, further comprising the steps of:
parsing out a plurality of links in said content;
editing information associated with said plurality of links;
compressing said information associated with said plurality of links; and
storing said compressed information in a cache.

11. The method according to claim 4, wherein said step of sending further comprises the step of:
sending said request for content through a second network.

12. The method according to claim 11, wherein said first network is selected from the group consisting of: and Intranet and an Internet Service Provider.

13. The method according to claim 4, further comprising the step of:
intercepting said request for content by a Distribution Server.

14. The method according to claim 13, further comprising the step of:
connecting said Distribution Server to a Control Server residing on a private network.

15. The method according to claim 14, further comprising the steps of:
checking a cache associated with said Distribution Server for said content in compressed form;
wherein if compressed content is available, returning said compressed content to said first network; and
wherein if compressed content is unavailable, retrieving said content by means of said Control Server from said server.

16. The method according to claim 15, further comprising the step of:
accessing said Control Server by means of a direct connection with said Distribution Server.

17. The method according to claim 13, wherein said Distribution Server comprises one of a plurality of Distribution Servers residing on a second network.

18. The method according to claim 13, wherein said Distribution Server comprises one of a plurality of Distribution Servers, each residing on a separate network.

19. The method according to claim 15, further comprising the step of:
accessing said Control Server by means of the Internet.

20. The method according to claim 4, further comprising the step of:
scanning said uncompressed content.

21. The method according to claim 4, wherein said second network comprises:
the Internet.

22. A system for increasing speed of content delivery to a terminal while conserving bandwidth, said system comprising:
a first network for sending a request for content;
a source server containing said content;
a first node located intermediate to said first network and said source server, for intercepting said request;
a redirector coupled to said first node, for receiving said request from said first node and directing uncompressed content;
an editor, coupled to said redirector for editing said uncompressed content;
a compressor, coupled to said editor, for compressing said edited uncompressed content; and
a cache for storing the compressed content.

23. The system according to claim 22, wherein said first node comprises:
a Proxy Server.

24. The system according to claim 22, wherein said editor identifies at least one of a plurality of types of tags within said content.

25. The system according to claim 24, wherein said one of a plurality of types of tags is selected from the group consisting of: JPEG, GIF, PNG and HREF.

26. The system according to claim 22, wherein said content comprises:
a URL.

27. The system according to claim 22, wherein said first network comprises:
the Internet.

28. The system according to claim 22, wherein said request is sent through a second network.

29. The system according to claim 28, wherein said second network is selected from the group consisting of: an Internet Service Provider and an Intranet.

30. The system according to claim 22, wherein said first node comprises:
a Distribution Server, for intercepting said request from said first network and checking for availability of said content in a compressed form.

31. The system according to claim 30, wherein said Distribution Server is coupled to a Control Server, said Control Server residing on a second network.

32. A system for increasing speed of content delivery to a local computer while conserving bandwidth, said system comprising:
a first network for sending a request for content;
a server containing said content;
a first node located intermediate to said first network and said server, for intercepting said request;
a redirector coupled to said first node, for receiving said request from said first node and directing uncompressed content;
a scanner, coupled to said redirector, for scanning said uncompressed content;
a compressor, coupled to said scanner, for compressing said uncompressed content; and
a cache for storing the compressed content.

33. The system according to claim 32, wherein said scanner submits said uncompressed content to said compressor.

34. A method for shielding a web server from external networks and providing content from the web server to a requester, said method comprising the steps of:
receiving a request, by a network node, from a requester for delivery of content;
checking a cache associated with said network node for availability of said content in compressed form;
wherein if said content is available in said compressed form, retrieving said content in said compressed form from said cache;
wherein if said content is not available in said compressed form, retrieving said content in an uncompressed form from said web server connected to said network node;
compressing said uncompressed content in said network node; and
storing said content in said cache in a compressed form, whereby said content is available upon a subsequent request from at lease one external network.

35. The method according to claim 34, further comprising the step of:
delivering said content to said requester in a compressed form.

36. The method according to claim 34, further comprising, prior to said storing step, the step of:
editing said content, wherein said storing step stores the edited content in a compressed form.
